(19) United States
(12) Patent Application Publication
(10) Pub. No.: US 2025/0193613 A1
(43) Pub. Date: Jun. 12, 2025

(54) HEARING INSTRUMENT AND METHOD FOR OPERATING THE HEARING INSTRUMENT

(71) Applicant: Sivantos Pte. Ltd., Singapore (SG)

(72) Inventor: Peter NIKLES, Erlangen (DE)

(21) Appl. No.: 18/976,624

(22) Filed: Dec. 11, 2024

(30) Foreign Application Priority Data
Dec. 12, 2023 (DE) 10 2023 212 515.3

(51) Int. Cl. H04R 25/00

(52) U.S. Cl. CPC H04R 25/554; H04R 25/30; H04R 25/602; H04R 2225/021; H04R 2225/31; H04R 2225/51

(57) ABSTRACT

A hearing instrument has a housing to be worn behind the ear or in the ear in a designated wearing position. A battery, a wireless communications apparatus, and a capacitive sensor are arranged in the housing. The wireless communications apparatus includes an antenna and a transceiver unit electrically connected thereto. The capacitive sensor has at least one sensor electrode and a control and evaluation circuit electrically connected thereto. One or both of the battery or the antenna, or at least a portion of the antenna, are used as a sensor electrode of the capacitive sensor.

### CROSS-REFERENCE TO RELATED APPLICATION

This application claims the priority, under 35 U.S.C. § 119, of German Patent Application DE 10 2023 212 515.3, filed Dec. 12, 2023; the prior application is herewith incorporated by reference in its entirety.

### FIELD AND BACKGROUND OF THE INVENTION

The invention relates to a hearing instrument having a housing worn behind the ear or in the ear in a designated wearing position. Further, the invention relates to a method for operating such a hearing instrument.

A hearing instrument generally refers to an electronic device that assists a person wearing the hearing instrument (who is referred to as “wearer” or “user” below) with the ability to hear. In particular, the invention relates to hearing instruments that are configured to fully or partly compensate for a hearing loss of a hearing-impaired user. Such a hearing instrument is referred to as a “hearing aid.” Additionally, there are hearing instruments that protect or improve the ability of users with normal hearing to hear, for example enable improved speech comprehension in complex hearing situations. Hearing instruments furthermore also include wireless headphones (worn in or on the ear), in particular so-called ear plugs and headsets.

Hearing instruments in general, and specifically hearing aids, are usually embodied to be worn on the head of the user and, in particular, in or on an ear in this case, in particular as behind-the-ear devices (BTE devices) or in-the-ear devices (ITE devices). In terms of their internal structure, hearing instruments regularly comprise at least one (acousto-electric) input transducer, a signal processing unit (signal processor), and an output transducer. During the operation of the hearing instrument, the input transducer or each input transducer records airborne sound from the surroundings of the hearing instrument and converts this airborne sound into an (input) audio signal (i.e., an electrical signal that transports information about the ambient sound). The input audio signal or each input audio signal is processed in the signal processing unit (i.e., modified in terms of its sound information) in order to assist the ability of the user to hear, in particular to compensate for a loss of hearing of the user. The signal processing unit outputs an appropriately processed (output) audio signal to the output transducer. In addition or as an alternative to frequency-dependent amplification of the input audio signal, signal processing in modern hearing instruments regularly encompasses a multiplicity of other functions, e.g. beamforming (i.e., direction-dependent damping), active noise suppression, wind noise suppression, feedback damping, binaural processing to support spatial hearing, dynamic and/or spectral compression, etc.

In most cases, the output transducer is in the form of an electro-acoustic transducer, which converts the (electrical) output audio signal back into airborne sound, wherein this airborne sound-which is being modified in relation to the ambient sound—is output into the auditory canal of the user. In the case of a hearing instrument that is worn behind the ear, the output transducer, which is also referred to as “receiver,” is usually integrated in a housing of the hearing instrument outside of the ear. The sound output by the output transducer is guided into the auditory canal of the user by means of a sound tube in this case. In an alternative thereto, the output transducer can also be arranged in the auditory canal, and consequently outside of the housing worn behind the ear. Such hearing instruments are also referred to as RIC devices (from “receiver-in-canal”). In-the-ear hearing instruments which are dimensioned to be so small that they do not protrude beyond the auditory canal to the outside are also referred to as CIC devices (from “completely-in-canal”).

In further embodiments, the output transducer can also be in the form of an electromechanical transducer, which converts the output audio signal into structure-borne sound (vibrations). The structure-borne sound is then, for example, output to the cranial bone of the user.

A “hearing system” generally refers to an arrangement of devices and optionally other structures that provide functions for operating a hearing instrument. In the simplest case, the hearing system consists only of the hearing instrument itself. As a rule, however, in addition to the hearing instrument, the hearing system comprises at least one peripheral device that interacts with hearing instrument when the latter is in operation, e.g. a further hearing instrument for the other ear of the user, a remote control, an external microphone, a programming device for the hearing instrument or a charger. In addition to the hearing instrument, modern hearing systems often also provide a software application that can be installed on a computer (especially a portable computer), e.g. a smartphone or a tablet computer, and that contributes functions to the operation of the hearing instrument (e.g. remote control, programming, firmware updates, data backup, complex signal processing and/or an Internet connection). The computer on which this software application (hereinafter referred to as “hearing app”) is installed is also a peripheral device of the hearing instrument, which is data-connected to the hearing instrument, when the hearing instrument is in operation. However, the computer is not normally part of the hearing system itself, insofar as it is manufactured and distributed independently of the components of the hearing system and can be used for a multiplicity of other applications not connected to the hearing system. Rather, the computer (i.e., the user's smartphone or tablet computer in particular) is used by the hearing app only as an external resource for computing power, storage space and communication services.

The proper functioning of a hearing instrument, and thus the benefit that the hearing instrument brings to its wearer in daily operation, depends crucially on the fit of the housing in or on the wearer's ear. In other words, the hearing instrument can as a rule only satisfactorily fulfill the task intended therefor if it is arranged in the designated wearing position behind the ear or in the ear.

Firstly, this is because the signal processing of the hearing instrument is calibrated to a specific acoustic situation at the location of the microphone or each microphone of the hearing instrument, e.g. to a certain alignment of the at least one microphone with respect to the head and to certain acoustic shadowing of the microphone or each microphone by the ear. If the housing of the hearing instrument is inserted behind the ear or in the ear in a manner that deviates from the designated wearing position, then this changes the acoustic situation to which the microphone or each microphone is exposed, and hence also the input audio signal recorded by the microphone or each microphone. Signal processing calibrated for a different acoustic situation regularly can no longer optimally handle the input audio signal recorded by mispositioned microphones. For example, this can manifest itself in that misaligned beamforming leads to damping the used signal (e.g. the voice of a conversation partner) wanted by the user rather than an unwanted background noise, in that active noise suppression and binaural signal processing no longer function satisfactorily, etc.

Impaired acoustic sealing of the auditory canal by the hearing instrument might occur as a further undesirable effect of a mispositioning of the housing. In a BTE device, a misalignment of the housing might for example lead to the connector being stressed or bent too much, and hence exerting a tensile load on the earpiece that pulls all of the earpiece, or parts thereof, out of the ear. Impaired acoustic sealing of the auditory canal can lead to undesirable side effects in turn, such as, for example, increased noise levels or the occurrence of acoustic feedback.

However, experience has shown that relatively older people, in particular, who represent a typical group of hearing instrument users on account of age-related loss of hearing, frequently have significant difficulties with using hearing instruments correctly.

### SUMMARY OF THE INVENTION

Against this background, the problem addressed by the invention is that of enabling an improved check for the correct fit of a hearing instrument.

With the above and other objects in view there is provided, in accordance with the invention, a hearing instrument, comprising:
a housing to be worn behind an ear or in the ear of a user in a designated wearing position;
a battery, a wireless communications apparatus, and a capacitive sensor arranged in the housing;
the wireless communications apparatus including an antenna and a transceiver unit electrically connected thereto;
the capacitive sensor including at least one sensor electrode and a control and evaluation circuit electrically connected thereto; and
the battery and/or the antenna, or at least a portion of the antenna, being configured for use as a sensor electrode of the capacitive sensor.

In other words, the above and other objects are achieved, in accordance with the invention, by providing a hearing instrument having a housing that should be worn in a designated wearing position behind the ear or in the ear of a user. Thus, the hearing instrument can be either a BTE (behind-the-ear) device or an ITE (in-the-ear) device, as described at the outset. In the case of a BTE device, the hearing instrument comprises an earpiece to be placed in the ear of the user and a flexible connecting part that connects between the housing and the earpiece, in addition to the housing worn behind the ear. In this case, the hearing instrument is either a conventional hearing instrument having a receiver arranged in the housing or an RIC (receiver-in-canal) device in which the receiver is arranged in the earpiece. In the former case, the connector is formed by a sound tube, which supplies the sound produced by the receiver to the earpiece. In the latter case, the connector is an electrical connecting cable by means of which the output audio signal is supplied to the receiver arranged in the earpiece.

In all of the embodiments described above, a battery, a wireless communications apparatus and a capacitive sensor are also arranged in the housing.

The wireless communications apparatus serves for wireless data exchange between the hearing instrument and a peripheral device, e.g. another hearing instrument or a smartphone of the user, and comprises an antenna and a transceiver unit electrically connected thereto.

The capacitive sensor enables detection of generally dielectric or electrically conductive structures in the vicinity of the sensor, specifically body structures such as e.g. the head and ear of the user in particular. The capacitive sensor comprises at least one sensor electrode and a control and evaluation circuit (also referred to as “sensor controller”) electrically connected thereto. In the hearing instrument according to the invention, the capacitive sensor is used in particular to check the correct fit of the housing in the ear or behind the ear. What is exploited here is the fact that, on account of the variety of surrounding body structures of the user, the (capacitive) sensor signal output by the capacitive sensor depends in a characteristic manner on the fit of the housing behind the ear or in the ear. In other words, the sensor signal output by the capacitive sensor changes in a characteristic manner when the user displaces the housing of the hearing instrument behind the ear or in the ear. It was recognized that the correct fit of the housing in the designated wearing position can be recognized on the basis of this dependence of the capacitive sensor signal.

However, since hearing instruments are very small devices, it was recognized that arranging the at least one sensor electrode in the housing is problematic. In particular, the surface of the housing in hearing instruments is usually occupied virtually exclusively by the battery and the antenna of the wireless communications apparatus. Arranging the at least one sensor electrode of the capacitive sensor next to the battery and the antenna would only be possible if the antenna and the sensor electrode had sufficiently small dimensions; however, it was recognized that this would significantly impair the function both of the wireless communications apparatus and of the capacitive sensor.

To avoid this dilemma, the battery and/or the antenna of the wireless communications apparatus or at least a portion of the same are additionally used as sensor electrode of the capacitive sensor in the hearing instrument according to the invention. In other words, according to the invention, the sensor electrode or at least one of, optionally, a plurality of sensor electrodes of the capacitive sensor are formed by the battery or the antenna or an antenna portion.

As a result, housing the at least one sensor electrode in the housing requires no additional space in the housing—in comparison with conventional hearing instruments having a battery and wireless communications apparatus but no capacitive sensor. The space available within the housing can be used effectively, both for the realization of the antenna and for the realization of the at least one sensor electrode, and so both the wireless communications apparatus and the capacitive sensor can be operated without hindering one another.

The control and evaluation circuit (sensor controller) of the capacitive sensor is preferably configured to apply an alternating voltage (also referred to as “(capacitive) sensor voltage”) to the sensor electrode and measure a response signal created under the action of this alternating voltage, the response signal being characteristic of an electrical capacitance associated with the sensor electrode. The control and evaluation circuit (sensor controller) is preferably embodied as a microcontroller. In this case, the functionality of the control and evaluation circuit is implemented as software. However, the control and evaluation circuit can also be embodied as a non-programmable (analog or digital) electrical circuit within the scope of the invention. The control and evaluation circuit in both cases either can be embodied as a separate component (e.g. as a separate integrated circuit) or can be integrated in a larger structural unit, e.g. in the signal processor of the hearing instrument, together with other functions. The sensor voltage can be created either as a sinusoidal signal or with a different time curve (e.g. as a rectangular pulse signal, triangular pulse signal or sawtooth pulse signal). In the process, it can vary around the zero voltage or a different voltage mean value.

In particular, the capacitive sensor can be based on one of two inherently conventional functional principles within the scope of the invention.

According to a first functional principle, referred to, for example, as “single-electrode measurement” or “self-capacitance measurement” (self-capacitance sensing), the control and evaluation circuit measures the response signal at the same sensor electrode to which it applies the sensor voltage. As a capacitance-dependent response signal, the control and evaluation circuit measures, for example, the current flowing under the effect of the sensor voltage on the at least one sensor electrode or the frequency of the sensor voltage (wherein the fact that the sensor electrode is part of a resonant circuit with a resonance that depends on the capacitance is exploited). In all cases, the response signal here is characteristic of the (electrical) capacitance of the at least one sensor electrode in relation to an external ground potential. In the “single-electrode measurement”, the external ground potential formed here e.g. by the body of the user acts as a counter-electrode of the capacitor whose capacitance is measured by the sensor.

According to a second functional principle, referred to, for example, as “two-electrode measurement”, “transmitter/receiver principle,” or “relative capacitance measurement” (mutual capacitance sensing), the control and evaluation circuit applies the sensor voltage to a first sensor electrode (transmitting electrode) and measures the response signal at another sensor electrode (receiving electrode). As a capacitance-dependent response signal, the control and evaluation circuit in this case measures, for example, the current created under the effect of the sensor voltage via an electric field in the receiving electrode. In this case, the response signal is characteristic of the (electrical) capacitance of the capacitor formed by the two sensor electrodes. In the “two-electrode measurement,” the body of the user acts as a disturbance potential which changes the capacitance of the capacitor formed by the two sensor electrodes and is detected thereby.

As mentioned above, the capacitive sensor of the hearing instrument according to the invention can be embodied either as “self-capacitance sensor” or as “mutual capacitance sensor.”

By preference the wireless communications apparatus is configured to emit and receive electromagnetic radiation (radio waves) at a radio frequency of more than 100 MHZ, preferably more than 1 GHZ, and in particular 2.4 GHz. In this case, the communications apparatus is designed, in particular, to transmit and receive data pursuant to the Bluetooth standard.

In an expedient configuration, the control and evaluation circuit of the capacitive sensor is configured to create the sensor voltage at an AC voltage frequency that is substantially smaller (preferably at least by a factor of 10, in particular by at least a factor of 100) than the radio frequency of the wireless communications apparatus. This spectral separation avoids unwanted interaction between the wireless communications apparatus and the capacitive sensor. In a preferred embodiment of the invention, the control and evaluation circuit of the capacitive sensor is configured to create the sensor voltage at an AC voltage frequency of less than 10 MHz.

To avoid capacitive sensor interference, a frequency-selective filter is interposed between the capacitive control and evaluation circuit and the sensor electrode or each sensor electrode in an expedient configuration of the invention. This filter preferably has different configurations depending on whether the battery or the antenna is used to form the respective sensor electrode. For example, a high-pass filter (blocking DC voltage) is preferably used as frequency-selective filter if the sensor electrode is the battery. By contrast, the frequency-selective filter is preferably formed by a low-pass filter (blocking the radio frequency of the wireless communications apparatus) if the sensor electrode is the antenna or an antenna portion. In both cases, a bandpass filter can be used in an alternative within the scope of the invention, the said bandpass filter transmitting the AC voltage of the capacitive sensor but blocking both DC voltages and the radio frequency of the wireless communications apparatus.

In an advantageous embodiment of the invention, the antenna comprises a first (antenna) portion and a second (antenna) portion, wherein the two antenna portions are electrically separated from one another for low-frequency signals at the AC frequency of the capacitive sensor. By preference, the two antenna portions are at least predominantly arranged on different sides of the housing, which are opposite one another in particular. In the case of a hearing instrument embodied as a conventional BTE or RIC device, in which the housing is worn behind the ear in the designated wearing position, one of these two sides of the housing in particular faces the head of the user in the designated wearing position, while the other side of the housing faces away from the head of the user in the designated wearing position.

In the case of the antenna divided into two portions, it is optionally only one of the two antenna portions that is used as sensor electrode of the capacitive sensor. In an alternative—and by preference—the two portions of the antenna are used as different sensor electrodes of the capacitive sensor. In an expedient embodiment of the invention, the two sensor electrodes are operated independently of one another here. Thus, a respective independent response signal is measured at the two sensor electrodes, rendering possible a differentiated detection of body structures in the surroundings of the housing and hence a particularly precise detection of the fit of the hearing instrument. In an alternative embodiment of the invention, the two antenna portions used as sensor electrodes interact as transmitter and receiver electrode of the capacitive sensor-operating according to the “transmitter/receiver principle” in this case.

A further embodiment of the invention relates to a hearing system that comprises the hearing instrument according to the invention (in particular in one of the variants described above) and a fit-monitoring unit. In this case, the fit-monitoring unit is configured to check the fit of the housing on the ear of the user on the basis of a sensor signal output by the capacitive sensor. The fit-monitoring unit, implemented either as a software module or as a non-programmable electronic circuit, preferably performs this check by comparing the sensor signal output by the capacitive sensor with a stored reference value. Since the shape of the head and ear is individual to each user, the reference value is also preferably determined on an individual basis in this case for the respective user. In an alternative embodiment, the fit-monitoring unit comprises a neural network, which is supplied with the sensor signal of the capacitive sensor and which is trained, in particular on an individual basis, for the respective user in order to check the fit of the hearing instrument on the basis of the sensor signal. The fit-monitoring unit is preferably integrated in the hearing instrument. In this case, the hearing system can also consist only of the hearing instrument itself, which is equipped with the fit-monitoring unit. In an alternative, the fit-monitoring unit is located outside the hearing instrument, e.g. in a peripheral device or software application (hearing app) of the hearing system.

The fit-monitoring unit is also configured to cause a message to be output to inform the user of the deviating fit of the housing should the fit be determined as deviating from the designated wearing position. This message is preferably displayed by outputting a text message or a visual cue (e.g. in the form of a schematic illustration of the hearing instrument housing arranged on the ear) on a peripheral device, e.g. on the display of a smartphone of the user by a hearing app associated with the hearing instrument. In addition to that or in an alternative, the message is output by the hearing instrument itself, e.g. in the form of a signal tone, a voice message output via the receiver of the hearing instrument or by a tactile signal (e.g. vibration).

In a further embodiment, the fit-monitoring unit is configured to adjust at least one signal processing parameter of the hearing instrument on the basis of the capacitive sensor signal output by the capacitive sensor, in order to adapt the signal processing (i.e., the function of the signal processor) of the hearing instrument to the fit of the housing. In particular, the fit-monitoring unit adapts the alignment of a beamformer of the hearing instrument in such a way that a determined deviation of the fit of the housing with respect to the designated wearing position is compensated.

In a particularly preferred embodiment of the invention, the fit-monitoring unit is configured to combine the two above-described embodiment variants by virtue of adjusting at least one signal processing parameter of the hearing instrument (in particular the alignment of a beamformer) if a small deviation of the fit from the designated wearing position is determined, in order to adapt the signal processing of the hearing instrument to the fit of the housing, and to prompt the output of the message indicating the deviating fit of the housing to the user only if the fit is determined as deviating quite significantly from the designated wearing position.

The method according to the invention uses the hearing instrument according to the invention in one of the embodiments described above. The statements made above in relation to embodiments and component parts of the hearing instrument and the associated effects and advantages therefore also apply mutatis mutandis to corresponding embodiments of the method, and vice versa.

In the course of the method according to the invention, a capacitive sensor signal is ascertained as a measure for the fit of the housing behind or in the ear of the user using the battery and/or the antenna or a portion of the same as sensor electrode of the capacitive sensor. In this case, a message indicating the deviating fit of the housing is output should the fit be determined as deviating from the designated wearing position. In addition to that or in an alternative, at least one signal processing parameter of the hearing instrument is adjusted on the basis of the capacitive sensor signal output by the capacitive sensor, in order to adapt the signal processing of the hearing instrument to the fit of the housing.

Other features which are considered as characteristic for the invention are set forth in the appended claims.

Although the invention is illustrated and described herein as embodied in a hearing instrument and method for operating same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic illustration of a hearing system having a hearing instrument and a software application (hearing app) installed on a smartphone of the user, wherein the hearing instrument is designed as a hearing aid with an output transducer (receiver) to be arranged in the auditory canal of the user and a housing that is wearable behind an ear of a user in a designated wearing position, wherein, inter alia, a battery, a wireless communications apparatus having an antenna and a capacitive sensor are arranged in the housing, and wherein the battery and/or the antenna or a portion of the same are used as sensor electrode of the capacitive sensor,

FIG. 2 shows an exploded view of a specific realization of the hearing instrument as per FIG. 1 with an opened housing,

FIG. 3 shows a perspective illustration of the battery, the antenna and an electronics frame of the hearing instrument indicated using dashed lines,

FIG. 4 shows a schematic illustration of an embodiment of the wireless communications apparatus and of the capacitive sensor, in which two portions of the antenna are used as different sensor electrodes of the capacitive sensor and wherein the two antenna portions are wired to a control and evaluation circuit of the capacitive sensor, in such a way that they interact as transceiver electrode and that the control and evaluation circuit measures a response signal that is characteristic of the capacitance of the capacitor formed by the two antenna portions,

FIG. 5 shows, in an illustration similar to FIG. 4, an alternative embodiment of the wireless communications apparatus and of the capacitive sensor, in which two portions of the antenna are likewise used as different sensor electrodes of the capacitive sensor but wherein the two antenna portions are wired to a control and evaluation circuit of the capacitive sensor, in such a way that they are operated as mutually independent sensor electrodes and that the control and evaluation circuit measures a response signal at each of the two antenna portions, the response signal being characteristic of the capacitance of the respective antenna portion in relation to an external ground potential,

FIG. 6 shows, in an illustration similar to FIG. 4, a variant of the embodiment of the wireless communications apparatus and of the capacitive sensor found there, in which the two terminals of the battery are used as further sensor electrodes of the capacitive sensor, in addition to the two antenna portions, and

FIG. 7 shows a schematic illustration of an example of a warning message displayed on a display of the smartphone prompted by a fit-monitoring unit of the hearing system should the fit-monitoring unit determine that the housing fit deviates significantly from the designated wearing position on the basis of a sensor signal of the capacitive sensor.

Parts and quantities corresponding to one another are identified with the same reference signs throughout the figures.

### DETAILED DESCRIPTION OF THE INVENTION

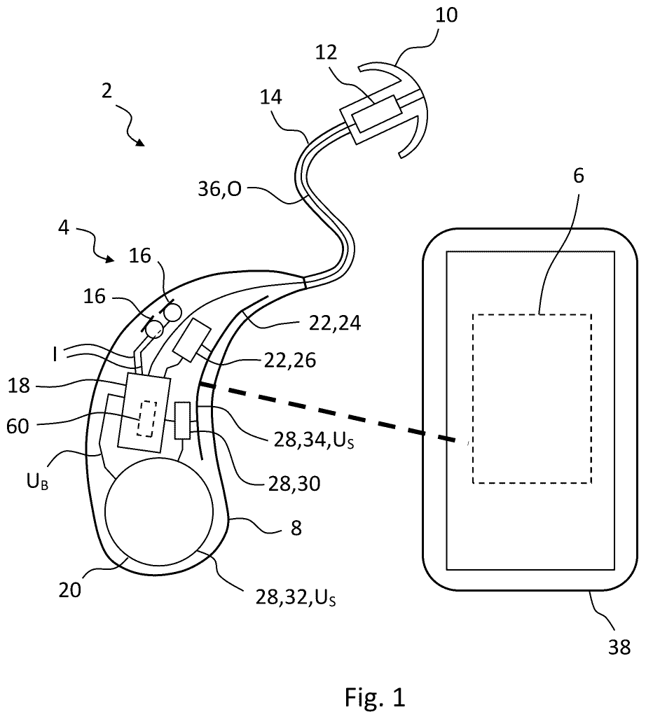

Referring now to the figures of the drawing in detail and first, in particular, to FIG. 1 thereof, there is shown a crude schematic illustration of a hearing system 2 that is formed from a hearing instrument 4 and an associated software application (hearing app 6).

By way of example, the hearing instrument 2 is a hearing aid, i.e., a hearing instrument configured to assist a hearing-impaired user with the ability to hear. In the embodiment depicted here, the hearing instrument 2 is embodied as an RIC device. Accordingly, it comprises a housing 8 worn behind an ear of a user when used as intended and an earpiece 10 inserted into the auditory canal of the user when used as intended, wherein an electro-acoustic output transducer (receiver 12) is integrated in the earpiece 10. The hearing instrument 2 furthermore comprises a flexible connector 14 that mechanically connects the housing 8 to the earpiece 10. In the case of the RIC device depicted in FIG. 1, the connector 14 comprises an electrical connection cable for the receiver 12.

The hearing instrument 4 comprises the following components within a housing 8:
at least one microphone 16 (two microphones 16 in the illustrated example) forming an input transducer;
a signal processor 18 (in particular a digital signal processor, DSP);
a battery 20;
a wireless communications apparatus 22 having an antenna 24 and a transceiver unit 26 electrically connected thereto; and
a capacitive sensor 28 formed of a control and evaluation circuit (sensor controller 30) and a plurality (two in the illustrated embodiment) of sensor electrodes 32 and 34.

During a normal operation of the hearing instrument 4, the microphones 16 each record airborne sound from the surroundings of the hearing instrument 4. The microphones 16 convert the sound into an (input) audio signal I, i.e., into an electrical signal that contains information about the recorded sound. The respective input audio signal I is supplied within the hearing instrument 4 to the signal processor 18, which modifies this input audio signal I to assist the ability of the user to hear, in particular amplifies said input audio signal in a frequency-selective manner to compensate for a hearing loss of the user.

Via an electrical signal line 36 guided in the housing 8 and through the connector 14, the signal processor 18 outputs an output audio signal O, i.e., once again an electrical signal, which in this case contains information about the processed and hence modified sound, to the receiver 12. The signal processor 18 and all other electrical or electronic components of the hearing instrument 4 are supplied from the battery 20 with a DC voltage referred to as operating voltage U_{B}.

The wireless communications apparatus 22 is used for (wireless) data exchange between the hearing instrument 4 and the hearing app 6 and/or optionally further components of the hearing system 2, e.g. a further hearing instrument 4 (not shown) for the other ear of the user.

The hearing app 6 serves in particular to remotely control and program the hearing instrument 4. In operation of the hearing system 2, the hearing app 6 is installed in executable fashion on a computer (in particular a portable computer). In the example shown, this computer is a smartphone 38 of the user. In this case, the computer itself, in particular the smartphone 38, is not a constituent part of the hearing system 2 but is used by the hearing app 6 only as an external resource for computing power, storage space and communication services. In particular, the hearing app 6 accesses a wireless communications apparatus (not shown in detail) of the smartphone 38 in order to exchange data with the hearing instrument 4. The wireless communications apparatus 22 of the hearing instrument 4 and the wireless communications apparatus of the smartphone 38 are generally embodied for the exchange of radio signals (also radio waves, specifically radiofrequency electromagnetic radiation above 100 MHz). Preferably, the data transfer between the hearing instrument 4 and the smartphone 38 (and hence the hearing app 6) is based on the Bluetooth standard, at a radio frequency of 2.4 GHz.

The capacitive sensor 28 serves to detect the fit of the housing 8 on the ear of the user, i.e., to check whether the housing 8 is in a designated wearing position or in a position deviating therefrom. In this case, the capacitive sensor 28 uses the battery 20 and/or the antenna 24 as sensor electrode(s) 32, 34. To this end, the battery 20 and antenna 24 are also electrically connected to the sensor controller 30. The sensor controller 30 controls the battery 20 used as sensor electrode 32 or the antenna 24 used as sensor electrode 34 with an AC voltage referred to as sensor voltage U_{S} whose AC voltage frequency is between 20 KHz and 10 MHz and for example is 100 kHz. The sensor voltage U_{S} is thus between and spectrally spaced apart from the operating voltage U_{B} produced by the battery 20 on the one hand and the radio frequency of the wireless communications apparatus 22 on the other hand.

The signal processor 18, the transceiver 26 and the sensor controller 30 are each formed either by a programmable circuit (e.g. a microprocessor) with software installed thereon or by a non-programmable circuit (e.g. in the form of an ASIC) or by a combination of at least one programmable subunit and at least one non-programmable subunit. As indicated by way of example in FIG. 1, the signal processor 18, the transceiver 26 and the sensor controller 30 can be formed as separate circuits in each case. In an alternative, the transceiver 26 and/or the sensor controller 30 with the signal processor 18 and/or at least one optionally present further control unit of the hearing instrument 4 are integrated in a common circuit.

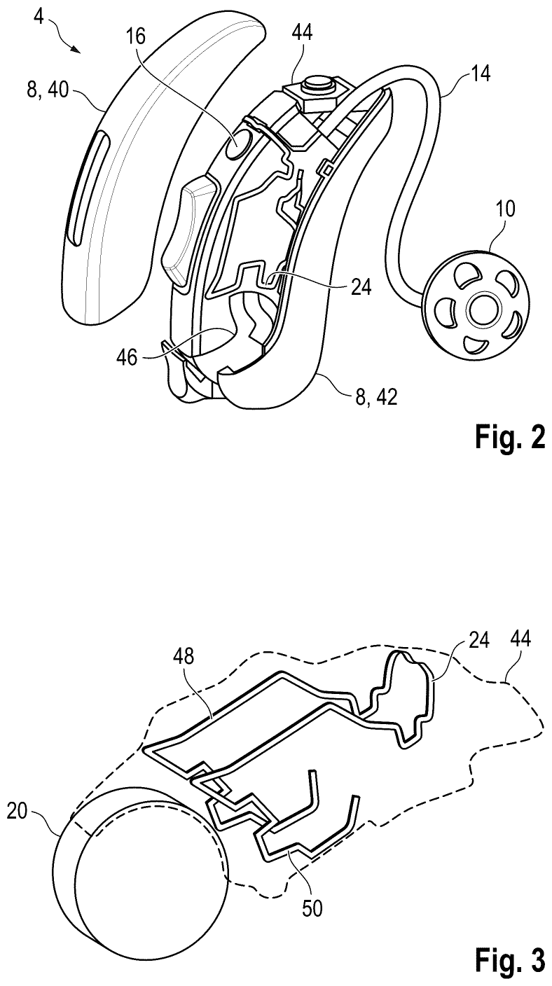

FIG. 2 shows a specific realization of the hearing instrument 4 from FIG. 1 with the housing 8 that is embodied in two parts here, comprising a housing lid 40 and a housing shell 42 that can be put together therewith. FIG. 2 shows the hearing instrument 4 in an exploded view, in which the housing lid 40 has been removed from the housing shell 42. This illustration shows an electronics frame 44 of the hearing instrument 4 which is inserted in the housing shell 42 and on which all electrical and electronic components of the hearing instrument 4 bar the receiver 12 are held, in particular the microphones 16, the signal processor 18, the battery 20 (in relation to which, however, FIG. 2 shows only an empty battery receptacle 46 of the electronics frame 44), the wireless communications apparatus 22 and the capacitive sensor 28. In this case, the antenna 24 is applied to the surface of the electronics frame 44. The arrangement of the battery 20 and antenna 24 with respect to the electronics frame 44 has been elucidated again in FIG. 3; in this case, the electronics frame 44 is only indicated by a dashed line.

The illustration of FIG. 3 makes clear that the antenna 24 is formed by two loop-shaped (antenna) portions 48 and 50, which are largely arranged on mutually opposing sides of the housing 8. In an embodiment of the hearing instrument 4 for the right ear of the user, the antenna portion 48 is arranged on the side of the housing 8 that faces the head of the user in the worn position while the antenna portion 50 is arranged on the side of the housing 8 facing away from the head of the user in the worn position. In an embodiment of the hearing instrument 4 for the left ear of the user, by contrast, the antenna portion 48 is arranged on the side of the housing 8 that faces away from the head of the user in the worn position while the antenna portion 50 is arranged on the side of the housing 8 facing the head of the user in the worn position. In terms of antenna design, the antenna 24 depicted in FIGS. 2 and 3 is a folding dipole antenna.

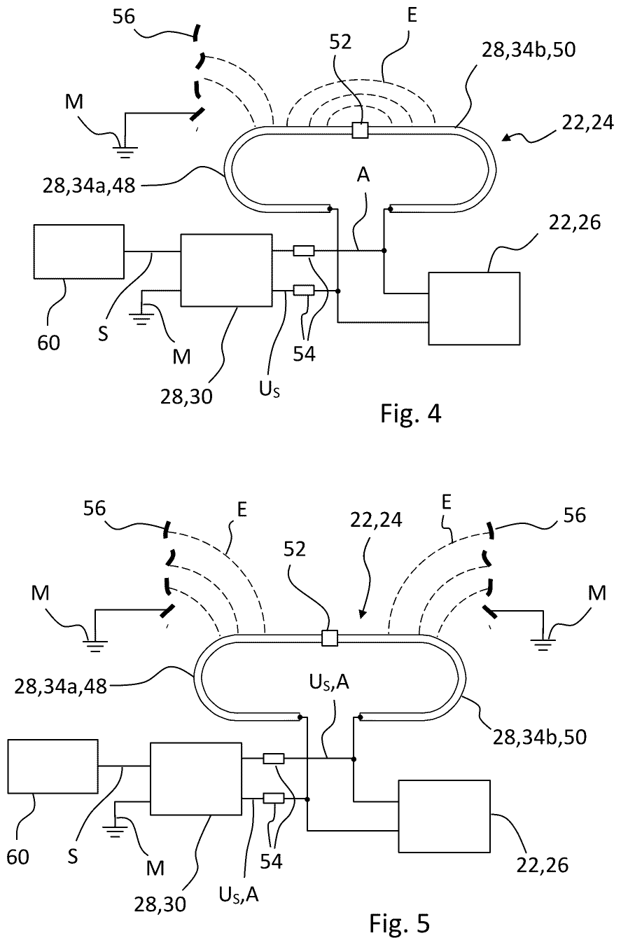

The antenna 24 can be used in different ways within the scope of the capacitive sensor 28. Thus, in one embodiment (indicated in FIG. 1), the entire antenna 24 is used as a single sensor electrode 34. In preferred embodiments, however, which are depicted in FIGS. 4 and 5, the two antenna portions 48 and 50 of the antenna 24 are used as different sensor electrodes 34a and 34b. In order to realize electrical separation between the two antenna portions 48, 50 or sensor electrodes 34a, 34b within the scope of the capacitive sensor 28 without impairing the function of the antenna 24 within the scope of the wireless communications apparatus 22, an electrical high-pass filter 52 (e.g. in the form of a capacitor) that transmits high-frequency electrical signals at radio frequency but blocks the lower frequency sensor voltage U_{S}, by contrast, is interposed between the two antenna portions 48 and 50. Furthermore, a respective further frequency-selective electrical filter, in this case in the form of an electrical low-pass filter 54 that transmits the sensor voltage U_{S} but blocks high-frequency electrical signals at radio frequency is connected in each of the electrical connections between sensor controller 30 and antenna portions 48 and 50.

In the two exemplary embodiments as per FIGS. 4 and 5, the two antenna portions 48 and 50 (also known as sensor electrodes 34a and 34b) are activated differently by the sensor controller 30.

In the embodiment as per FIG. 4, the sensor electrodes 34a and 34b are operated by the sensor controller 30 as transmitting electrode and receiving electrode. In this case, the sensor controller 30 applies the sensor voltage U_{S} to the sensor electrode 34a. Under the action of the sensor voltage U_{S}, the sensor electrode 34a creates an electric field E that alternates at the AC voltage frequency in a surrounding spatial volume and causes a charge displacement in the sensor electrode 34b, and hence an electric current flow. The sensor controller 30 preferably measures the current intensity of this current flow at the sensor electrode 34b as response signal A, said response signal A being characteristic of the (electrical) capacitance of the capacitor formed by the sensor electrodes 34a and 34b. The capacitive sensor 28 is thus embodied as a “relative capacity sensor” (mutual capacity sensor).

Body structures 56 of the user, e.g. the head and the ear, which are disposed in proximity of the housing 8 (and schematically indicated in FIG. 4) and behind which the housing 8 is worn act as a disturbance potential on account of the AC conductivity of the human body and the electrical connection of the body to the sensor controller 30 via ground M, the said disturbance potential reducing the capacitance of the capacitor formed by the sensor electrodes 34a and 34b, and thus the value of the measured response signal A, to an ever greater extent, the larger the body structure is and the closer it is disposed to the antenna 24.

In the embodiment as per FIG. 5, the sensor electrodes 34a and 34b are operated by the sensor controller 30 as separate (i.e., mutually independent) sensor electrodes. In this case, the sensor controller 30 applies the sensor voltage U_{S} to both sensor electrodes 34a and 34b and measures the response signal A, created under the action of the sensor voltage U_{S}, independently for each of the sensor electrodes 34a and 34b; in this case, too, the current intensity of the current flowing to the respective sensor electrode 34a, 34b is preferably measured as response signal A. In this case, the response signal A associated with the respective sensor electrode 34a, 34b is characteristic of the capacitance of the respective sensor electrodes 34a and 34b with respect to ground M. The capacitive sensor 28 is therefore embodied as a “self-capacity sensor” in this embodiment. The sensor voltage U_{S} is preferably applied to the two sensor electrodes 34a and 34b in phase, and so no electric field E extends between the two sensor electrodes 34a and 34b themselves.

The electric field E created by the respective sensor electrode 34a, 34b under the action of the control voltage U_{S} in this case extends between the respective sensor electrode 34a, 34b and the nearest body structures 56 of the user. The body structures 56, in particular the head and the adjacent ear, of the user located in the vicinity of the housing 8 and at ground potential M for AC voltages act as a counter electrode for the respective sensor electrode 34a, 34b in this embodiment of the capacitive sensor 28. In other words, each of the sensor electrodes 34a, 34b forms the capacitor, the capacitance of which is measured at the respective sensor electrode 34a, 34b, together with the nearest body structures 56. This capacitance, and hence the value of the measured response signal A—unlike in the embodiment as per FIG. 4—becomes ever higher the larger the body structures 56 are, and the closer they are arranged to the respective sensor electrode 34a, 34b.

In relation to the embodiment as per FIG. 4, the embodiment as per FIG. 5 is advantageous in that it provides two response signals A instead of a single response signal A, and hence it is able to detect the surroundings more accurately while having comparable structural complexity. However, the embodiment as per FIG. 5 is more susceptible to (unwanted) interferences than the embodiment as per FIG. 4.

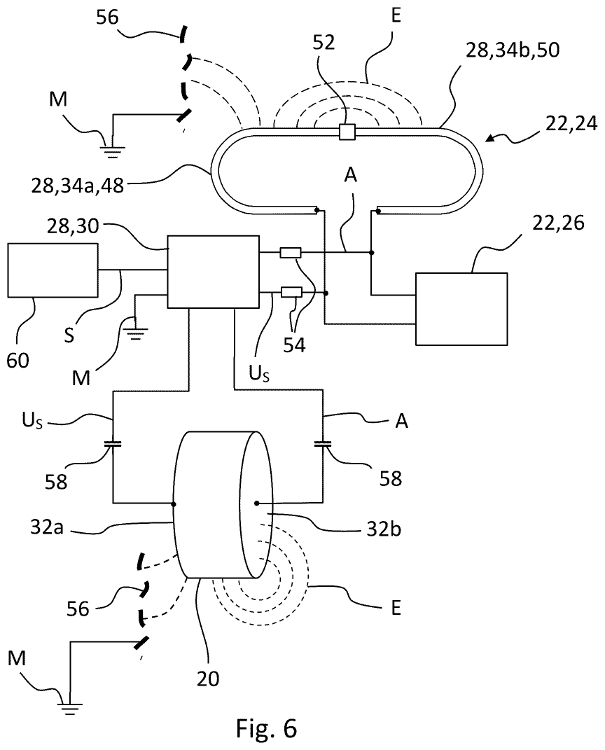

In a further embodiment as per FIG. 6, the two antenna portions 48, 50 (also known as sensor electrodes 34a, 34b) are operated as transmitting electrode and receiving electrode—in a manner analogous to the exemplary embodiment as per FIG. 4. However, in the embodiment as per FIG. 6, the sensor controller 30 additionally uses the two terminals of the battery 20 as further sensor electrodes 32a and 32b. In the embodiment as per FIG. 6, these sensor electrodes 32a and 32b are likewise operated as transmitting electrode and receiving electrode by the sensor controller 30 by virtue of the sensor controller 30 applying the sensor voltage U_{S} to the sensor electrode 32a and measuring the response signal A (specifically, in turn, the current intensity of the current flow created under the action of the sensor voltage U_{S} and of the electric field E caused thereby) at the sensor electrode 32b. In this case, the response signal A is characteristic of the capacitance of the capacitor formed by the sensor electrodes 32a and 32b. Hence, the capacitive sensor 28 is also formed as “relative capacity sensor” (mutual capacity sensor) in relation to the terminals of the battery 20 used as sensor electrodes 32a, 32b. In order to electrically decouple the sensor inputs and outputs of the sensor controller 30 from the operating voltage U_{B}, a respective frequency-selective electrical filter, in this case in the form of an electrical high-pass filter 58, is connected between the sensor controller 30 and each of the two terminals of the battery 20 (also known as the two sensor electrodes 32a and 32b), the filter transmitting the sensor voltage U_{S} but blocking the operating voltage U_{B} output by the battery 20 as DC voltage.

In addition to the exemplary embodiments of the capacitive sensor 28 described on the basis of FIGS. 4 to 6, numerous further embodiments that arise in particular from other combinations of the above-described configurations can be used within the scope of the invention. For example, the sensor electrodes 32a and 32b can also be operated as independent sensor electrodes—in a manner analogous to the exemplary embodiment as per FIG. 5—in a modification of the embodiment as per FIG. 6. Moreover, in a further modification of the embodiment as per FIG. 6, it is also possible to use one of the sensor electrodes 32a, 32b formed on the battery 20 with one of the sensor electrodes 34a, 34b formed on the antenna 24 as interacting pair of transmitting and receiving electrodes.

In all embodiments described above, the measured response signal A or each measured response signal is used in the operation of the hearing instrument 4 in a method for checking the fit of the hearing instrument 4. In order to automatically carry out this method, the hearing system 2 comprises a fit-monitoring unit 60 that is configured to use a sensor signal S output by the capacitive sensor 28 to check the fit of the housing 8 on the ear of the user, i.e., to determine whether the housing 8 is in a designated wearing position behind the ear of the user or whether the fit of the housing 8 deviates from the designated wearing position.

Within the scope of the invention, the fit-monitoring unit 60 might be formed by a non-programmable electronic circuit, e.g. in the form or as part of an ASIC. Preferably, however, the fit-monitoring unit 60 is formed by a software module which, for example, is installed in executable fashion on the signal processor 18 (see FIG. 1) or optionally another programmable control circuit of the hearing instrument 4. In a further embodiment of the invention, the fit-monitoring unit 60 is implemented as part of the hearing app 6 outside the hearing instrument 4.

The sensor signal S output from the sensor controller 30 to the fit-monitoring unit 60 contains the (unchanged) value of the or each response signal A or a quantity derived from it, for example, the capacitance assigned to the sensor electrode or each sensor electrode 32, 32a, 32b, 34, 34a, 34b or an inverted or scaled quantity.

In order to monitor the fit of the housing 8 behind the ear of the user, the fit-monitoring unit 60 compares the sensor signal S in a preferred configuration of the method with a stored reference value which reproduces the value of the sensor signal S when the housing 8 is positioned in the designated wearing position. Should the fit-monitoring unit 60 determine a significant deviation of the sensor signal S from the reference value (in particular a deviation that exceeds a predetermined tolerance value), it causes the output of a (warning) message to the user, which informs the user of the incorrect fit (i.e., a deviation from the designated wearing position) of the housing 8.

Since the value of the sensor signal S is also influenced by the approach of further body parts to the housing 8, e.g. the approach of a hand or a finger, but these disturbing influences are usually only short-lived, the fit-monitoring unit 60 is preferably embodied to only trigger the output of the warning message if the sensor signal S deviates significantly from the reference value for longer than a predetermined time interval (e.g. more than 2 min).

For example, the warning message is in the form of:
a beep output into the ear of the user via the receiver 12 or output by the hearing app 6 via a speaker of the smartphone 38,
a voice message output into the ear of the user via the receiver 12 or output by the hearing app 6 via a speaker of the smartphone 38,
a text message or graphic displayed by the hearing app 6 on the display of the smartphone 38, of
a tactile alarm (e.g. a vibration signal) output via the hearing instrument 4 or the smartphone 38, or
a combination of the above notification methods.

The reference value is preferably learned on an individual basis when the hearing instrument 4 is adapted to the user (during the fitting process), e.g. by virtue the sensor signal S being captured and stored as a reference value after the housing 8 was positioned in the correct designated wearing position behind the ear of the user by an audiology specialist.

In a developed embodiment of the invention, it is not only a single reference value for the sensor signal S that is stored in the fit-monitoring unit 60 but a function or characteristic curve or specific value table, which in addition to the characteristic specific value for the designated wearing position also contains specific values for deviating positions of the housing 8 behind the ear. For example, the function, characteristic curve or specific value table is likewise ascertained when the hearing instrument is adapted to the user, by virtue of the housing 8 being placed at different positions behind the ear by a specialist, and by virtue of the respective value of the sensor signal S being captured and stored in each position together with a position specification. According to the method, by comparing the current value of the sensor signal S with the function, characteristic curve or specific value table in operation of the hearing instrument 4, the fit-monitoring unit 60 in this embodiment determines whether the fit of the housing 8 corresponds to the designated wearing position not only in qualitative fashion. Rather, the fit-monitoring unit 60 in this case determines quantitatively how strongly and in which direction the fit of the housing 8 deviates from the designated wearing position.

If the fit-monitoring unit 60 in the aforementioned embodiment determines a significant deviation of the sensor signal S from the reference value ascertained for the designated wearing position, the said fit-monitoring unit causes (e.g. using one of the above-described methods) the output of a warning message to the user, which alerts the user to the incorrect fit of the housing 8 and contains instructions for correcting the fit.

Alternatively, the fit-monitoring unit 60 adjusts at least one signal processing parameter of the hearing instrument 4 on the basis of the sensor signal S output from the capacitive sensor 28 such that an effect of the mispositioning of the housing 8 is fully or partially compensated. For example, the fit-monitoring unit 60 adjusts a beamformer of the signal processor 18 of the hearing instrument 4 in such a way that a directional lobe of the beamformer is aligned with respect to the head of the user as in the designated wearing position (e.g. always perpendicular to the longitudinal axis of the head), even in the event of a mispositioned housing 8.

In a further refined embodiment of the invention, the fit-monitoring unit 60 follows a differentiated operational sequence of the method. In this case, the fit-monitoring unit 60 adapts the at least one signal processing parameter of the hearing instrument 4—as described above—to compensate for a detected misfit of the housing 8 only if the detected deviation of the fit of the housing 8 from the designated wearing position is small (in particular does not exceed a stored threshold value). Otherwise, i.e., in the event of more pronounced mispositioning of the housing 8, the fit-monitoring unit 60, as also described above, causes the output of the warning message, which alerts the user to the misfit of the housing 8 and contains an instruction for correcting the fit.

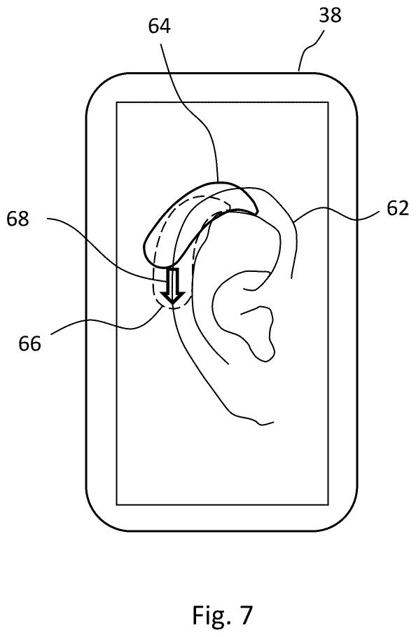

An example of a graphical variant of such a warning message displayed on the display of the smartphone 38 by the hearing app 6 when prompted by the fit-monitoring unit 60 is depicted in FIG. 7. The exemplary warning message contains an image representation of a human ear 62, a first image representation 64 of the housing 8 with the current fit as determined on the basis of the sensor signal S (shown in FIG. 7 using a solid line) and a further image representation 66 of the housing 8 in the designated wearing position (shown in FIG. 7 using a dashed line). The user can already gather the instructions in relation to correcting the fit from the depicted deviation between the two image representations 64 and 66 of the housing 8. As additional (optional) instructions for correcting the seat, the warning message contains an arrow 68, which instructs the user in the illustrated example to displace the housing 8 further downward on the ear.

In a further embodiment of the invention, the fit-monitoring unit 60 contains a neural network which is trained on the user on an individual basis, contains the sensor signal S as an input signal and causes at least one corrective action in the event of a significant misfit of the housing 8, in particular (as described above) an adaptation of at least one signal processing parameter of the hearing instrument 4 to compensate for the misfit and/or the output of a warning message to the user.

In further embodiments of the invention, the hearing instrument is a conventional BTE device having a housing that is worn behind the ear and a receiver arranged in this housing or an ITE device with a housing worn in the auditory canal. The statements made above as regards the embodiment and arrangement of the capacitive sensor and as regards checking the fit of the housing behind the ear or in the ear can be easily transferred to these types of device.

The invention becomes particularly clear on the basis of the exemplary embodiments described above, but it is not restricted thereto by any means. Rather, further embodiments of the invention may be derived from the claims and the description above.

The following is a summary list of reference numerals and the corresponding structure used in the above description of the invention:
2 Hearing system
4 Hearing instrument
6 Hearing app
8 Housing
10 Earpiece
12 Receiver
14 Connector
16 Microphone
18 Signal processor
20 Battery
22 (Wireless) communications apparatus
24 Antenna
26 Transceiver
28 (Capacitive) sensor
30 Sensor controller
32 Sensor electrode
32a Sensor electrode
32b Sensor electrode
34 Sensor electrode
34a Sensor electrode
34b Sensor electrode
36 Signal line
38 Smartphone
40 Housing lid
42 Housing shell
44 Electronics frame
46 Battery receptacle
48 (Antenna) portion
50 (Antenna) portion
52 High-pass filter
54 Low-pass filter
56 Body structure
58 High-pass filter
60 Fit-monitoring unit
62 Ear
64 Image representation
66 Image representation
68 Arrow
A Response signal
E (Electric) field
I Input signal
M Ground
O Output signal
U Operating voltage
U_{S} Sensor voltage
S Sensor signal
U_{B} Battery voltage, operating voltage

1. A hearing instrument, comprising:
a housing to be worn behind an ear or in the ear of a user in a designated wearing position;
a battery, a wireless communications apparatus, and a capacitive sensor arranged in said housing;
said wireless communications apparatus including an antenna and a transceiver unit electrically connected thereto;
said capacitive sensor including at least one sensor electrode and a control and evaluation circuit electrically connected thereto; and
at least one of said battery or said antenna, or at least a portion of said antenna, being configured for use as said at least one sensor electrode of said capacitive sensor.

2. The hearing instrument according to claim 1, wherein said control and evaluation circuit of said capacitive sensor is configured to apply an alternating voltage to said at least one sensor electrode and to measure a response signal that is responsive to the alternating voltage, the response signal being characteristic of an electrical capacitance associated with said at least one sensor electrode.

3. The hearing instrument according to claim 1, wherein said wireless communications apparatus is configured to emit and receive electromagnetic radiation at a radio frequency of more than 100 MHZ.

4. The hearing instrument according to claim 3, wherein said wireless communications apparatus is configured to emit and receive electromagnetic radiation at a radio frequency of more than 1 GHz.

5. The hearing instrument according to claim 3, wherein said wireless communications apparatus is configured to emit and receive electromagnetic radiation at a radio frequency of 2.4 GHz.

6. The hearing instrument according to claim 3, wherein said control and evaluation circuit of said capacitive sensor is configured to create the sensor voltage at an AC voltage frequency of less than 10 MHz.

7. The hearing instrument according to claim 2, wherein said control and evaluation circuit of said capacitive sensor is configured to create the sensor voltage at an AC voltage frequency of less than 10 MHz.

8. The hearing instrument according to claim 1, which further comprises a frequency-selective filter interposed between said capacitive control and evaluation circuit and said at least one sensor electrode (32, 32a, 32b, 34, 34a, 34b).

9. The hearing instrument according to claim 1, wherein said at least one sensor electrode is one of a plurality of sensor electrodes, and a frequency-selective filter is respectively interposed between said capacitive control and evaluation circuit and each of said sensor electrodes.

10. The hearing instrument according to claim 1, wherein:
said antenna comprises two portions, being a first portion and a second portion, and wherein:
only one of said two portions of said antenna is used as a sensor electrode of said capacitive sensor; or
said two portions of said antenna are used as different sensor electrodes of said capacitive sensor.

11. The hearing instrument according to claim 1, wherein said control and evaluation circuit of said capacitive sensor is configured to apply a sensor voltage to and measure the response signal at the same sensor electrode.

12. The hearing instrument according to claim 1, wherein:
said capacitive sensor comprises at least two sensor electrodes that are electrically connected to said control and evaluation circuit;
said control and evaluation circuit of said capacitive sensor is configured to apply a sensor voltage to one of said two sensor electrodes and to measure the response signal at another of said two sensor electrodes.

13. A hearing system, comprising:
a hearing instrument according to claim 1;
a fit-monitoring unit configured to check how the housing of the hearing instrument fits behind or in the ear of the user on a basis of a sensor signal output by the capacitive sensor and, when a placement of the housing is determined to deviate from a designated wearing position:
to cause a message to be output that indicates the deviating fit of the housing; and/or
to adjust at least one signal processing parameter of the hearing instrument on the basis of the sensor signal output by the capacitive sensor, in order to adapt a signal processing of the hearing instrument to the fit of the housing.

14. A method of operating a hearing instrument, the method comprising:
providing the hearing instrument according to claim 1;
ascertaining a sensor signal as a measure for the fit of the housing behind or in the ear of the user by using at least one of the battery or the antenna, or a portion of the antenna, as sensor electrode of the capacitive sensor; and
when the sensor signal indicates that a fit of the hearing instrument deviates from a designated wearing position, outputting a message indicating the deviating fit of the housing, and/or
adjusting at least one signal processing parameter of the hearing instrument on a basis of the sensor signal output by the capacitive sensor, in order to adapt a signal processing of the hearing instrument to the fit of the housing behind or in the ear of the user.
